(19) United States
(12) Patent Application Publication
(10) Pub. No.: US 2026/0050777 A1
(43) Pub. Date: Feb. 19, 2026

(54) METHOD AND APPARATUS FOR MAKING LEAKY INTEGRATE-FIRE AND RESET (LIFR) INTEGRATED CMOS CELLS

(71) Applicant: QUALCOMM Incorporated, San Diego, CA (US)

(72) Inventors: Abhijeet PAUL, San Diego, CA (US); Ravi Pramod Kumar VEDULA, San Diego, CA (US); Periannan CHIDAMBARAM, San Diego, CA (US)

(21) Appl. No.: 18/802,831

(22) Filed: Aug. 13, 2024

(51) Int. Cl. G06N 3/063

(52) U.S. Cl. CPC G06N 3/063

(57) ABSTRACT

An integrated circuit (IC) is described. The IC includes a leaky integrate-fire (LIF) complementary metal oxide semiconductor (CMOS) cell. The LIF CMOS cell is configured to receive an input spike train and having an output to fire in response to the input spike train. The IC also includes a reset field effect transistor (FET) switch coupled to the output of the LIF CMOS cell. The reset FET switch is configured to detect the fire at the output of the LIF CMOS cell in response to the input spike train and to reset the LIF CMOS cell.

### TECHNICAL FIELD

Certain aspects of the present disclosure relate to artificial neural networks and, more particularly, to a method and apparatus for making leaky integrate-fire and reset (LIFR) integrated complementary metal oxide semiconductor (CMOS) cells.

### BACKGROUND

An artificial neural network, which may include an interconnected group of artificial neurons, may be a computational device or may represent a method to be performed by a computational device. Artificial neural networks may have corresponding structure and/or function in biological neural networks. Artificial neural networks, however, may provide useful computational techniques for certain applications, in which traditional computational techniques may be cumbersome, impractical, or inadequate. Because artificial neural networks may infer a function from observations, such networks may be useful in applications where the complexity of the task and/or data makes the design of the function burdensome using conventional techniques.

Neuromorphic computing (NC) imitates the functions of the brain by utilizing a network of synthetic neurons interconnected among synaptic devices. Currently, implementation of neuromorphic neural hardware activation functions relies on bulk, power hungry designs, such as static random-access memory (SRAM)-based as well as comparator-based designs. Unfortunately, these SRAM-based and comparator-based designs exhibit a significant footprint, which significantly increases the size of an integrated circuit (IC) incorporating these designs. A leaky integrate-fire and reset (LIFR) integrated complementary metal oxide semiconductor (CMOS) cell to enable neuromorphic neural hardware activation functions is desired.

### SUMMARY

An integrated circuit (IC) is described. The IC includes a leaky integrate-fire (LIF) complementary metal oxide semiconductor (CMOS) cell. The LIF CMOS cell is configured to receive an input spike train and having an output to fire in response to the input spike train. The IC also includes a reset field effect transistor (FET) switch coupled to the output of the LIF CMOS cell. The reset FET switch is configured to detect the fire at the output of the LIF CMOS cell in response to the input spike train and to reset the LIF CMOS cell.

A processor-implemented method for a leaky integrate-fire and reset (LIFR) on a neuromorphic computing (NC) hardware activation (NCHWA) of a neural processing unit (NPU) is described. The method includes receiving an input spike train at a leaky integrate-fire (LIF) complementary metal oxide semiconductor (CMOS) cell. The method also includes firing, at an output of the LIF CMOS cell, in response to the input spike train. The method further includes detecting the firing at the output of the LIF CMOS cell in response to the input spike train. The method also includes resetting, by a reset field effect transistor (FET) switch coupled to the output of the LIF CMOS cell, the LIF CMOS cell.

This has outlined, broadly, the features and technical advantages of the present disclosure in order that the detailed description that follows may be better understood. Additional features and advantages of the disclosure will be described below. It should be appreciated by those skilled in the art that this disclosure may be readily utilized as a basis for modifying or designing other structures for conducting the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 illustrates an example implementation of a neuromorphic computing (NC) hardware activation (NCHWA) for a neural network using a system-on-chip (SoC), including a general-purpose processor, in accordance with certain aspects of the present disclosure.

FIGS. 2A, 2B, and 2C are diagrams illustrating a neural network, in accordance with various aspects of the present disclosure.

FIG. 2D is a diagram illustrating a neural network, in accordance with various aspects of the present disclosure.

FIGS. 3A and 3B are diagrams illustrating a neuromorphic network of synthetic neurons interconnected among synaptic devices to imitate the functions of the brain, according to various aspects of the present disclosure.

FIGS. 4A and 4B are graphs illustrating biological neural electrical activity and simulated integrate-fire behavior, according to various aspects of the present disclosure.

FIGS. 5A and 5B are schematic diagrams illustrating a leaky integrate-fire and reset (LIFR) integrated complementary metal oxide semiconductor (CMOS) cell to enable neuromorphic neural hardware activation functions, according to various aspects of the present disclosure.

FIGS. 6A and 6B are schematic diagrams illustrating a leaky integrate-fire and reset (LIFR) cell compact layout of the integrated circuit of FIGS. 5A and 5B, in accordance with various aspects of the present disclosure.

FIG. 7 is schematic diagram illustrating a leaky integrate-fire and reset (LIFR) integrated complementary metal oxide semiconductor (CMOS) cell to enable neuromorphic neural hardware activation functions, according to various aspects of the present disclosure.

FIG. 8 is a flow diagram illustrating a method for leaky integrate-fire and reset (LIFR) on a neuromorphic computing (NC) hardware activation (NCHWA) of a neural processing unit (NPU), according to various aspects of the present disclosure.

### DETAILED DESCRIPTION

The detailed description set forth below, in connection with the appended drawings, is intended as a description of various configurations and is not intended to represent the only configurations in which the concepts described may be practiced. The detailed description includes specific details for the purpose of providing a thorough understanding of the various concepts. Nevertheless, it will be apparent to those skilled in the art that these concepts may be practiced without these specific details. In some instances, well-known structures and components are shown in block diagram form to avoid obscuring such concepts.

Based on the teachings, one skilled in the art should appreciate that the scope of the disclosure is intended to cover any aspect of the disclosure, whether implemented independently of or combined with any other aspect of the disclosure. For example, an apparatus may be implemented, or a method may be practiced using any number of the aspects set forth. In addition, the scope of the disclosure is intended to cover such an apparatus or method practiced using other structure, functionality, or structure and functionality in addition to or other than the various aspects of the disclosure set forth. Any aspect of the disclosure disclosed may be embodied by one or more elements of a claim.

Although aspects are described, many variations and permutations of these aspects fall within the scope of the disclosure. Although some benefits and advantages of the preferred aspects are mentioned, the scope of the disclosure is not intended to be limited to benefits, uses, or objectives. Rather, aspects of the disclosure are intended to be universally applicable to different technologies, system configurations, networks, and protocols, some of which are illustrated by way of example in the figures and in the following description of the preferred aspects. The detailed description and drawings are merely illustrative of the disclosure, rather than limiting the scope of the disclosure being defined by the appended claims and equivalents thereof.

Neuromorphic computing (NC) imitates the functions of the brain by utilizing a network of synthetic neurons interconnected among synaptic devices. Currently, implementation of neuromorphic neural hardware activation functions rely on bulk, power hungry designs, such as static random-access memory (SRAM)-based as well as comparator-based designs. Unfortunately, these SRAM-based and comparator-based designs exhibit a significant footprint, which significantly increases the size of an integrated circuit (IC) incorporating these designs. Additionally, conventional implementation of neuromorphic neural hardware activation functions relies on a substantial number of active devices, which consume a significant amount of power in the digital domain.

Neuromorphic computing implementations incur a memory wall and an energy efficiency bottleneck in the von Neumann system due to the stagnation of Moore's law. An ideal artificial neuron possessing bio-inspired behaviors as exemplified by the requisite leaky-integrate-fire and self-reset (LIFR) functionalities within a single device is still lacking. Additionally, because the neural network hardware for performing inference is dense, successful implementation of neural network hardware involves artificial neuron cells exhibiting desired qualities. For example, artificial neuron cells exhibiting desired electrical behavior, while consuming a smaller area, may benefit from an analog implementation for lower energy consumption.

Various aspects of the present disclosure are directed to a leaky integrate-fire and reset (LIFR) integrated complementary metal oxide semiconductor (CMOS) cell to enable neuromorphic neural hardware activation functions. In various aspects of the present disclosure, an integrated circuit (IC) includes a leaky integrate-fire (LIF) complementary metal oxide semiconductor (CMOS) cell. In operation, the LIF CMOS cell is configured to receive an input spike train and an output of the LIF CMOS cell is configured to fire in response to the input spike train from, for example, a spike generator.

As described, the term “input spike train” may refer to the conversion of the reading from a sensor (e.g., a light sensor, camera, humidity sensor, etc.) into the neural network. Additionally, the IC includes a reset field effect transistor (FET) coupled to the output of the LIF CMOS cell to detect the fire in response to the input spike train and reset of the LIF CMOS cell. As described, the term “reset” may refer to a ready to process new signal state, which occurs once an older signal has been processed and sent to a next stage. For example, once the input signal has been processed by a given neuron, the neuron is a reset and ready to process a new incoming signal for a next step.

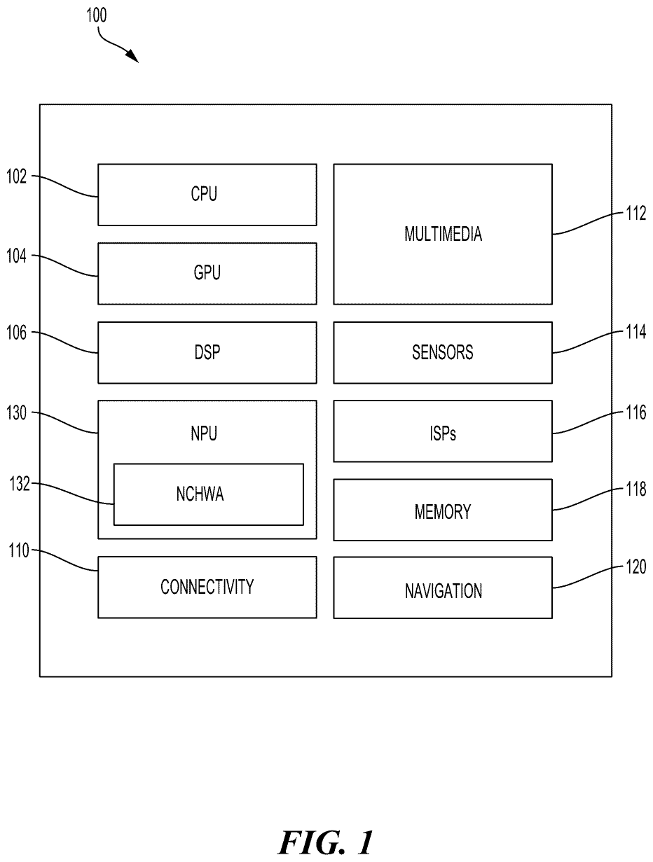

FIG. 1 illustrates an example implementation of a neuromorphic computing (NC) hardware activation (NCHWA) for a neural network using a system-on-chip (SoC), which may include a central processing unit (CPU) 102 or multi-core CPUs, in accordance with certain aspects of the present disclosure. Variables (e.g., neural signals and synaptic weights), system parameters associated with a computational device (e.g., neural network with weights), delays, frequency bin information, and task information may be stored in a memory block associated with a neural processing unit (NPU) 130, in a memory block associated with a CPU 102, in a memory block associated with a graphics processing unit (GPU) 104, in a memory block associated with a digital signal processor (DSP) 106, in a memory block 118, or may be distributed across multiple blocks. Instructions executed at the CPU 102 may be loaded from a program memory associated with the CPU 102 or may be loaded from a memory block 118.

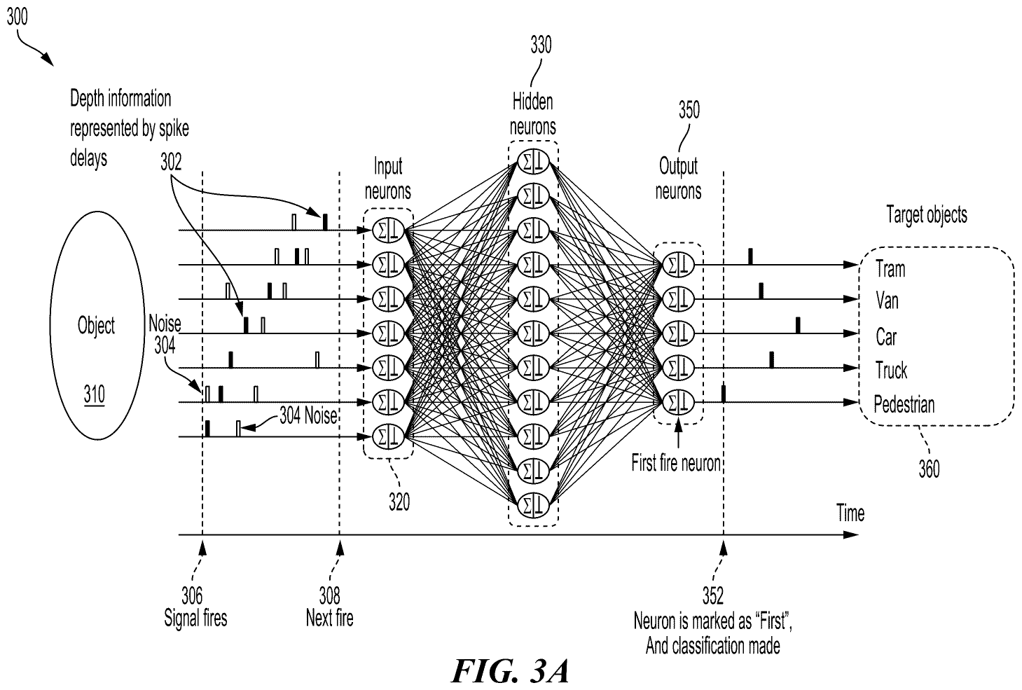

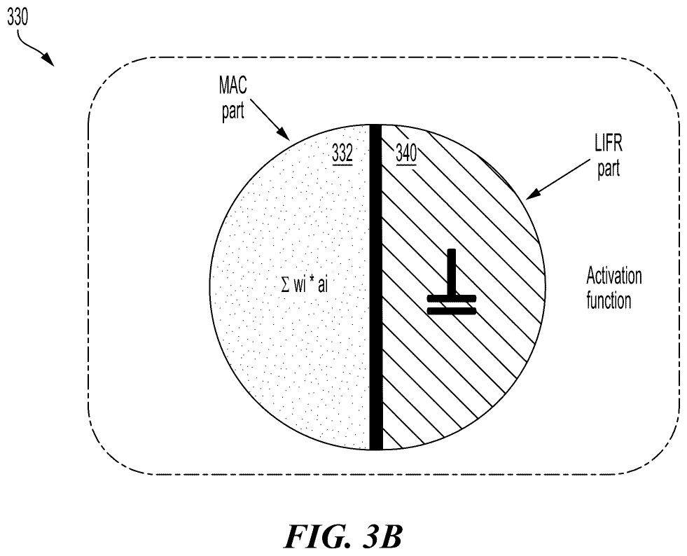

One aspect of the present disclosure is directed to a neuromorphic computing (NC) hardware activation (NCHWA) 132 of the NPU 130. Various aspects of the present disclosure are directed to a leaky integrate-fire and reset (LIFR) integrated complementary metal oxide semiconductor (CMOS) cell to enable the neuromorphic computing neural hardware activation functions of the NCHWA 132 of the NPU 130. An integrated circuit (IC) includes a leaky integrate-fire (LIF) complementary metal oxide semiconductor (CMOS) cell and a reset field effect transistor (FET) coupled to an output of the LIF CMOS cell to detect the fire in response to an input spike train and resets the LIF CMOS cell. In various aspects of the present disclosure, the LIF CMOS cell and the reset FET are implemented using a partially depleted (PD) semiconductor-on-insulator (PDSOI) wafer that is smaller (e.g., 30%) relative to a process of record (POR) cell design. This substantial cell size reduction relative to the POR cell design beneficially leads to significantly smaller neural-network layout size, for example, as shown in FIG. 3A.

The SoC 100 may also include additional processing blocks tailored to specific functions, such as a connectivity block 110, which may include fifth generation (5G) new radio (NR) connectivity, fourth generation long term evolution (4G LTE) connectivity, unlicensed Wi-Fi connectivity, USB connectivity, Bluetooth connectivity, and the like, and a multimedia processor 112 that may, for example, detect and recognize gestures. In one implementation, the NPU is implemented in the CPU, DSP, and/or GPU. The SoC 100 may also include a sensor processor 114 to provide sensor image data, image signal processors (ISPs) 116, and/or navigation module 120, which may include a global positioning system.

Deep learning architectures may perform an object recognition task by learning to represent inputs at successively higher levels of abstraction in each layer, thereby building up a useful feature representation of the input data. In this way, deep learning addresses a major bottleneck of traditional machine learning. Prior to the advent of deep learning, a machine learning approach to an object recognition problem may have relied heavily on human engineered features, in combination with a shallow classifier. A shallow classifier may be a two-class linear classifier, for example, in which a weighted sum of the feature vector components may be compared with a threshold to predict to which class the input belongs. Human engineered features may be templates or kernels tailored to a specific problem domain by engineers with domain expertise. Deep learning architectures, in contrast, may learn to represent features that are like what a human engineer might design, but through training. Furthermore, a deep network may learn to represent and recognize new types of features that a human might not have considered.

A deep learning architecture may learn a hierarchy of features. If presented with visual data, for example, the first layer may learn to recognize simple features, such as edges, in the input stream. In another example, if presented with auditory data, the first layer may learn to recognize spectral power in specific frequencies. The second layer, taking the output of the first layer as input, may learn to recognize combinations of features, such as simple shapes for visual data or combinations of sounds for auditory data. For instance, higher layers may learn to represent complex shapes in visual data or words in auditory data. Still higher layers may learn to recognize common visual objects or spoken phrases.

Deep learning architectures may perform especially well when applied to problems that have a natural hierarchical structure. For example, the classification of motorized vehicles may benefit from first learning to recognize wheels, windshields, and other features. These features may be combined at higher layers in diverse ways to recognize cars, trucks, and airplanes.

Neural networks may be designed with a variety of connectivity patterns. In feed-forward networks, information is passed from lower to higher layers, with each neuron in each layer communicating to neurons in higher layers. A hierarchical representation may be built up in successive layers of a feed-forward network, as described above. Neural networks may also have recurrent or feedback (also called top-down) connections. In a recurrent connection, the output from a neuron in each layer may be communicated to another neuron in the same layer. A recurrent architecture may be helpful in recognizing patterns that span more than one of the input data chunks that are delivered to the neural network in a sequence. A connection from a neuron in each layer to a neuron in a lower layer is called a feedback (or top-down) connection. A network with many feedback connections may be helpful when the recognition of a high-level concept may aid in discriminating the low-level features of an input.

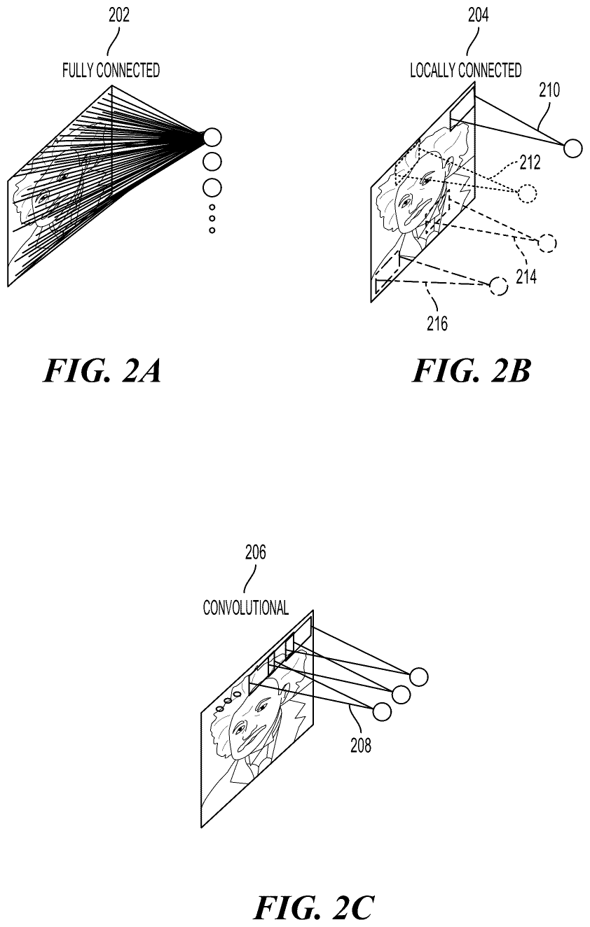

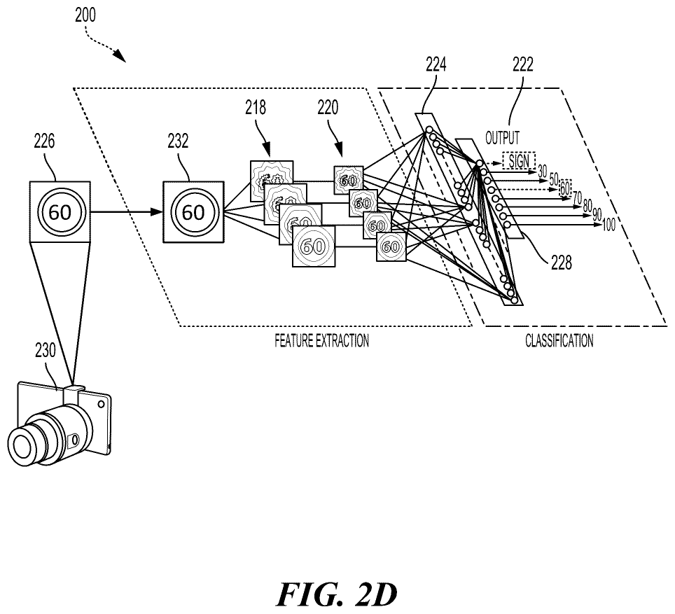

The connections between layers of a neural network may be fully connected or locally connected. FIG. 2A illustrates an example of a fully connected neural network 202. In a fully connected neural network 202, a neuron in a first layer may communicate its output to every neuron in a second layer, so that each neuron in the second layer will receive input from every neuron in the first layer. FIG. 2B illustrates an example of a locally connected neural network 204. In a locally connected neural network 204, a neuron in a first layer may be connected to a limited number of neurons in the second layer. More generally, a locally connected layer of the locally connected neural network 204 may be configured so that each neuron in a layer will have the same or a similar connectivity pattern, but with connection strengths that may have different values (e.g., 210, 212, 214, and 216). The locally connected connectivity pattern may give rise to spatially distinct receptive fields in a higher layer because the higher layer neurons in each region may receive inputs that are tuned through training to the properties of a restricted portion of the total input to the network.

One example of a locally connected neural network is a convolutional neural network. FIG. 2C illustrates an example of a convolutional neural network 206. The convolutional neural network 206 may be configured such that the connection strengths associated with the inputs for each neuron in the second layer are shared (e.g., 208). Convolutional neural networks may be well suited to problems in which the spatial location of inputs is meaningful.

One type of convolutional neural network is a deep convolutional network (DCN). FIG. 2D illustrates a detailed example of a DCN 200 designed to recognize visual features from an image 226 input from an image capturing device 230, such as a car-mounted camera. The DCN 200 of the current example may be trained to identify traffic signs and a number provided on the traffic sign. Of course, the DCN 200 may be trained for other tasks, such as identifying lane markings or identifying traffic lights.

The DCN 200 may be trained with supervised learning. During training, the DCN 200 may be presented with an image, such as the image 226 of a speed limit sign, and a forward pass may then be computed to produce an output 222. The DCN 200 may include a feature extraction section and a classification section. Upon receiving the image 226, a convolutional layer 232 may apply convolutional kernels (not shown) to the image 226 to generate a first set of feature maps 218. As an example, the convolutional kernel for the convolutional layer 232 may be a 5×5 kernel that generates 28×28 feature maps. In the present example, because four different convolutional kernels were applied to the image 226 at the convolutional layer 232, four different feature maps are generated in the first set of feature maps 218. The convolutional kernels may also be referred to as filters or convolutional filters.

The first set of feature maps 218 may be subsampled by a max pooling layer (not shown) to generate a second set of feature maps 220. The max pooling layer reduces the size of the first set of feature maps 218. That is, a size of the second set of feature maps 220, such as 14×14, is less than the size of the first set of feature maps 218, such as 28×28. The reduced size provides similar information to a subsequent layer while reducing memory consumption. The second set of feature maps 220 may be further convolved via one or more subsequent convolutional layers (not shown) to generate one or more subsequent sets of feature maps (not shown).

In the example of FIG. 2D, the second set of feature maps 220 is convolved to generate a first feature vector 224. Furthermore, the first feature vector 224 is further convolved to generate a second feature vector 228. Each feature of the second feature vector 228 may include a number that corresponds to a feature of the image 226, such as “sign,” “60,” and “100.” A SoftMax function (not shown) may convert the numbers in the second feature vector 228 to a probability. As such, an output 222 of the DCN 200 is a probability of the image 226 including one or more features.

In the present example, the probabilities in the output 222 for “sign” and “60” are higher than the probabilities of the others of the output 222, such as “30,” “40,” “50,” “70,” “80,” “90,” and “100.” Before training, the output 222 produced by the DCN 200 is likely to be incorrect. Thus, an error may be calculated between the output 222 and a target output. The target output is the ground truth of the image 226 (e.g., “sign” and “60”). The weights of the DCN 200 may then be adjusted so the output 222 of the DCN 200 is more closely aligned with the target output.

Neuromorphic computing (NC) imitates the functions of the brain by utilizing a network of synthetic neurons interconnected among synaptic devices. Currently, implementation of neuromorphic neural hardware activation functions rely on bulk, power hungry designs, such as static random-access memory (SRAM)-based as well as comparator-based designs. Unfortunately, these SRAM-based and comparator-based designs exhibit a significant footprint, which significantly increases the size of an integrated circuit (IC) incorporating these designs. Additionally, conventional implementation of neuromorphic neural hardware activation functions relies on a substantial number of active devices, which consume a significant amount of power in the digital domain. An ideal artificial neuron possessing bio-inspired behaviors as exemplified by the requisite leaky-integrate-fire and self-reset (LIFR) functionalities within a single device is still lacking. A leaky integrate-fire and reset (LIFR) integrated complementary metal oxide semiconductor (CMOS) cell to enable neuromorphic neural hardware activation functions is desired.

FIGS. 3A and 3B are diagrams illustrating a neuromorphic network 300 of synthetic neurons interconnected among synaptic devices to imitate the functions of the brain, according to various aspects of the present disclosure. In various aspect of the present disclosure, the neuromorphic network 300 is configured as a fully connected (FC) neural network, including interconnected input neurons 320, hidden neurons 330, and output neurons 350. In this example, classification of an object 310 is performed, in which depth information regarding the object 310 is present as spike delays 302, which are shown with associated noise 304 in response to signal fires 306 (e.g., light detection and ranging (LiDAR)), reacting to the object 310, before a next fire 308 as the interconnected input neurons 320. In this example, a first to fire neuron 352 of the output neurons 350 classifies the object 310 as a pedestrian from a group of target objects 360.

FIG. 3B is a block diagram further illustrating one of the hidden neurons 330, in accordance with various aspects of the present disclosure. As shown in FIG. 3B, the one of the hidden neurons 330 includes a multiply-accumulate (MAC) portion 332 and a leaky integrate-fire and reset (LIFR) portion 340. The MAC portion 332 is further described in co-pending US Patent Application No. XX/XXX,XXX. In some aspects of the present disclosure, the LIFR portion 340 is implemented using a partially depleted (PD) semiconductor-on-insulator (SOI) wafer for enabling neuromorphic neural hardware activation functions.

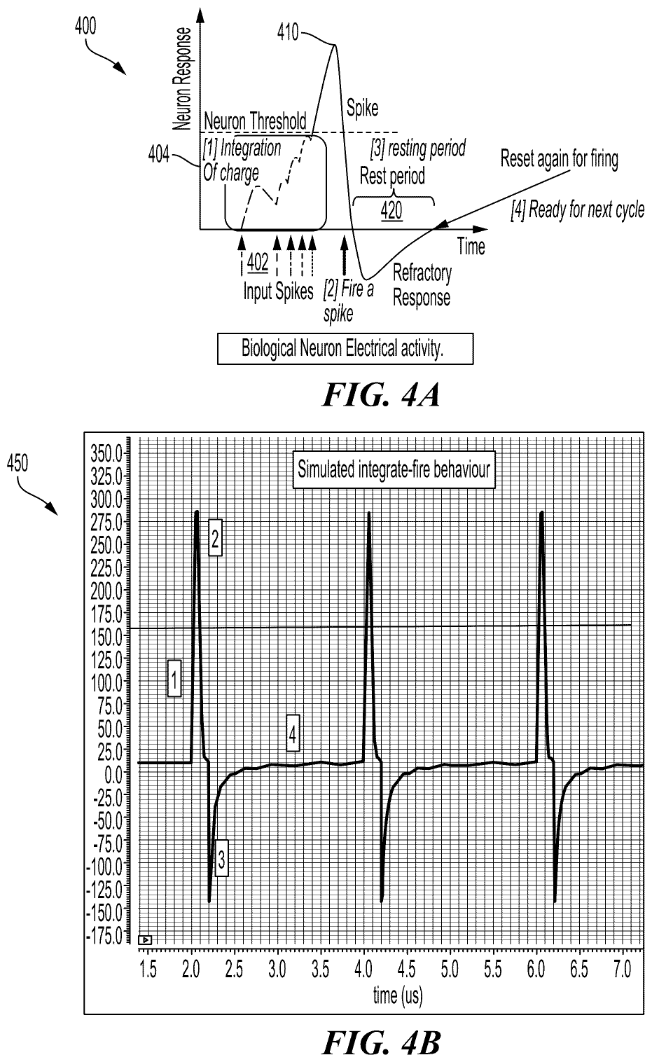

FIGS. 4A and 4B are graphs illustrating biological neural electrical activity and simulated integrate-fire behavior, according to various aspects of the present disclosure. In FIG. 4A, a biological neural electrical activity graph 400 is illustrated as a time vs. neural response graph illustrating various stages. During a first (1) integration of charge stage, input spikes 402 are illustrated relative to a neuron threshold 404. During a second (2) fire spike stage, the input spikes 402 reach the neuron threshold 404, resulting in firing of a spike 410. During a third (3) resting period stage, the spike 410 falls below a zero-neuron response as part of a rest period 420 during a refractory response. During a fourth (4) ready for next cycle stage, the biological neural electrical activity is reset and ready for firing.

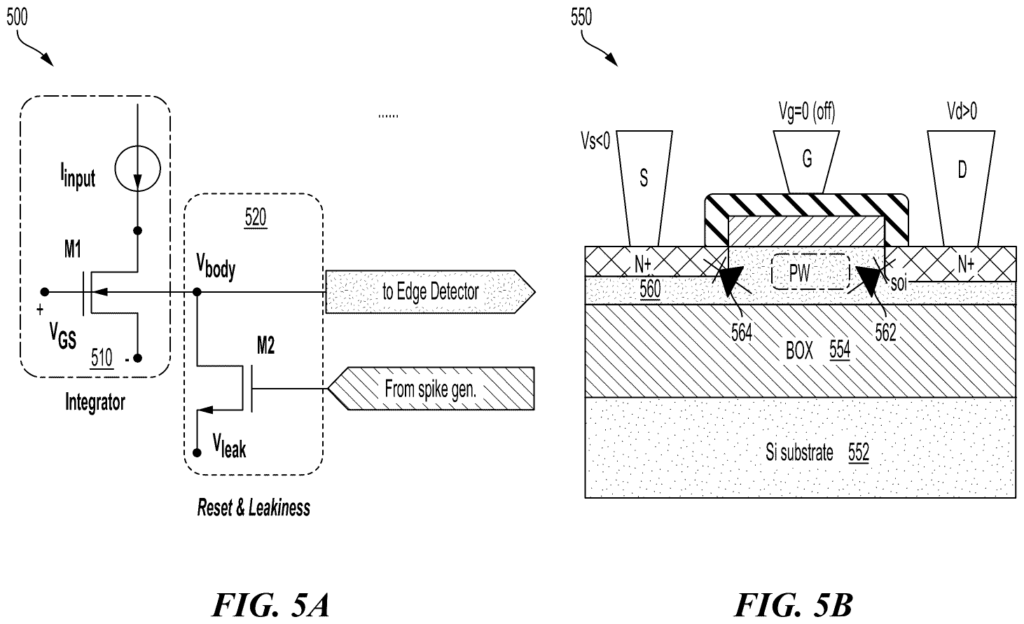

In FIG. 4B, a simulated integrate-fire behavior graph 450 illustrates the first (1) integration of charge stage, the second (2) fire spike stage, the third (3) resting period stage, and the fourth (4) ready for next cycle stage of a leaky integrate-fire and reset (LIFR) device. In FC neural networks, the LIFR device forms a sizable portion of the network, consuming a substantial portion of chip area. Designing a LIFR device having a small footprint and low power consumption is crucial for implementing low power artificial intelligence of things (AIOT)/extended reality (XR) types of applications. A LIFR integrated complementary metal oxide semiconductor (CMOS) cell is shown, for example, in FIGS. 5A and 5B.

FIGS. 5A and 5B are schematic diagrams illustrating a leaky integrate-fire and reset (LIFR) integrated complementary metal oxide semiconductor (CMOS) cell to enable neuromorphic neural hardware activation functions, according to various aspects of the present disclosure. As shown in FIG. 5A, an integrated circuit (IC) 500 includes a leaky integrate-fire (LIF) CMOS cell 510. In this example, the LIF CMOS cell 510 is coupled to an input spike train (e.g., Iᵢₙₚᵤₜ), and an output of the LIF CMOS cell 510 is configured to fire in response to the input spike train from, for example, a spike generator. Additionally, the IC 500 includes a reset field effect transistor (FET) switch 520 coupled to the output (e.g., the body) of the LIF CMOS cell 510 to detect the fire in response to the input spike train and reset the LIF CMOS cell 510. Additionally, in this example, an edge detector, or other like object detector/classifier is coupled to the body of the LIF CMOS cell 510.

FIG. 5B illustrates a cross-sectional view of the LIF CMOS cell 510 of FIG. 5A. According to various aspects of the present disclosure, the LIF CMOS cell 510 of FIG. 5A is implemented using the isolated body of a partially depleted (PD) semiconductor-on-insulator (SOI) (PDSOI) N-type FET 550. In this configuration, the PDSOI N-type FET 550 includes a silicon substrate 552 supporting a buried oxide (BOX) layer 554, and an SOI layer 560. In this example, the PDSOI N-type FET 550 is configured to implement spiking neural network activation functions. During operation, a body (e.g., P-well (PW)) of the PDSOI N-type FET 550 acts as a charge collector (natural integrator). In this example, once the total collected charge in the body exceeds the diode (e.g., source(S) side) connection bias, then the drain (D) side fires.

Referring again to FIG. 5A, based on firing of a transistor MI of the LIF CMOS cell 510, the remaining charge is drained off from the body (e.g., PW) using a transistor M2 of the reset FET switch 520 (e.g., leak and reset) coupled to the body of the LIF CMOS cell 510. As shown in FIG. 5B, during operation a gate voltage (Vg) is set to an off state (e.g., maintain Vg=off (0 or −0.1V for nFET)). Additionally, a drain voltage (Vd) remains positive (e.g., Vd>0), resulting in a reverse-biased, drain-body diode 562, until a fire threshold voltage (e.g., V_fire_thrshold) is exceeded. By contrast, a source voltage (Vs) remains negative (e.g., Vs<0), resulting in a forward-biased, source-body diode 564, leading to voltage leaking. Additionally, a high drain side field leads to drain side parallel hole collection. In the body (e.g., PW), voltage build-up occurs. Eventually, the drain-body diode 562 is forward-biased and leaks the holes (e.g., on top of the source-body diode 564).

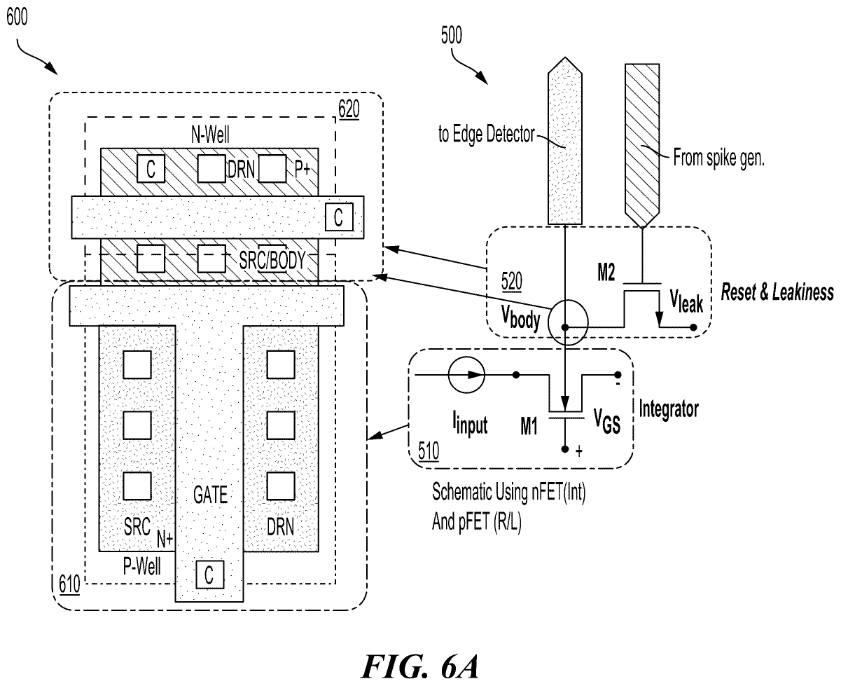

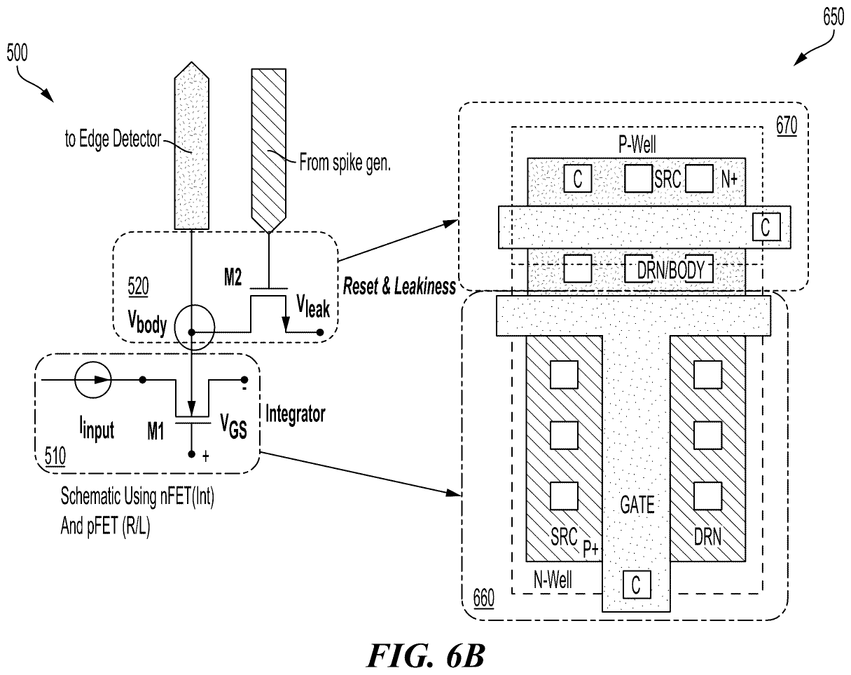

FIGS. 6A and 6B are schematic diagrams illustrating a leaky integrate-fire and reset (LIFR) cell compact layout of the IC 500 of FIGS. 5A and 5B, in accordance with various aspects of the present disclosure. FIG. 6A illustrates a cell layout 600 of a four-terminal body contacted N-type field effect transistor (FET) 610 implementation of the LIF CMOS cell 510 according to a diode-based cell layout. The four-terminal body contacted N-type FET 610 includes a P-type well (P-Well), including N+ source and drain regions, a gate (e.g., poly), as well as contacts (C). Additionally, FIG. 6A, illustrates a P-type FET 620 implementation of the reset FET switch 520 of the IC 500. The P-type FET 620 includes an N-type well (N-Well), including P+ drain and source/body regions, a gate (e.g., poly), as well as contacts (C).

FIG. 6B illustrates a cell layout 650 of a four-terminal body contacted P-type FET 660 implementation of the LIF CMOS cell 510 of the IC 500. The four-terminal body contacted P-type FET 660 includes an N-type well (N-Well), including P+source and drain regions, a gate (e.g., poly), as well as contacts (C). Additionally, FIG. 6B illustrates an N-type FET 670 implementation of the reset FET switch 520 of the IC 500. The N-type FET 670 includes a P-type well (P-Well), including N+ drain and source/body regions, a gate (e.g., poly), as well as contacts (C). As shown in FIGS. 6A and 6B, implementation of the LIF CMOS cell 510 and the reset FET switch 520 using a partially depleted (PD) semiconductor-on-insulator (SOI) (PDSOI) wafer as well as the diode-based cell layout provides a smaller (e.g., 30%) cell design relative to a process of record (POR) cell design, which are further described in FIGS. 5A and 5B.

As shown in FIGS. 5A and 5B, the PDSOI N-type FET 550 is configured to implement spiking neural network activation functions according to a diode-based cell layout. During operation, a body (e.g., P-well (PW)) of the PDSOI N-type FET 550 acts as a charge collector (natural integrator). In this example, once the total collected charge in the body exceeds the diode (e.g., source(S) side) connection bias, then the drain (D) side fires. As shown in FIG. 5B, during operation the gate voltage (Vg) is set to the off state (e.g., maintain Vg=off (0 or −0.1V for nFET)). Additionally, the drain voltage (Vd) remains positive (e.g., Vd>0), resulting in a reverse-biased, drain-body diode 562, until a fire threshold voltage (e.g., V_fire_thrshold) is exceeded. By contrast, the source voltage (Vs) remains negative (e.g., Vs<0), resulting in a forward-biased, source-body diode 564, leading to voltage leaking. Additionally, a high drain side field leads to drain side parallel hole collection. In the body (e.g., PW), voltage build-up occurs. Eventually, the drain-body diode 562 is forward-biased and leaks the holes (e.g., on top of the source-body diode 564).

The use of the PDSOI N-type FET 550 according to a diode-based cell layouts shown in FIG. 6A and 6B enables replacement of SRAM-based and comparator-based designs utilized by conventional neuromorphic hardware activation functions, which exhibit a significant footprint. This substantial cell size reduction provided by the diode-based cell layouts relative to the POR cell design beneficially leads to a significantly smaller neural-network layout size, for example, as shown in FIG. 3A.

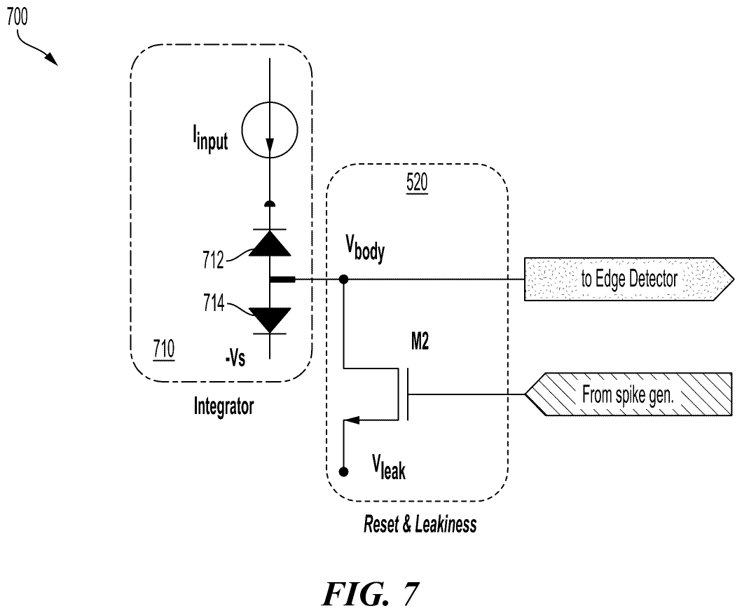

FIG. 7 is schematic diagram illustrating a leaky integrate-fire and reset (LIFR) integrated complementary metal oxide semiconductor (CMOS) cell to enable neuromorphic neural hardware activation functions, according to various aspects of the present disclosure. As shown in FIG. 7, an integrated circuit (IC) 700 is like the IC 500 of FIG. 5A and is described using similar reference numbers. In various aspects of the present disclosure, the IC 700 includes a leaky integrate-fire (LIF) complementary metal oxide semiconductor (CMOS) cell 710 implemented using a back-to-back diode connection in place of the transistor M1, as shown in FIG. 5A.

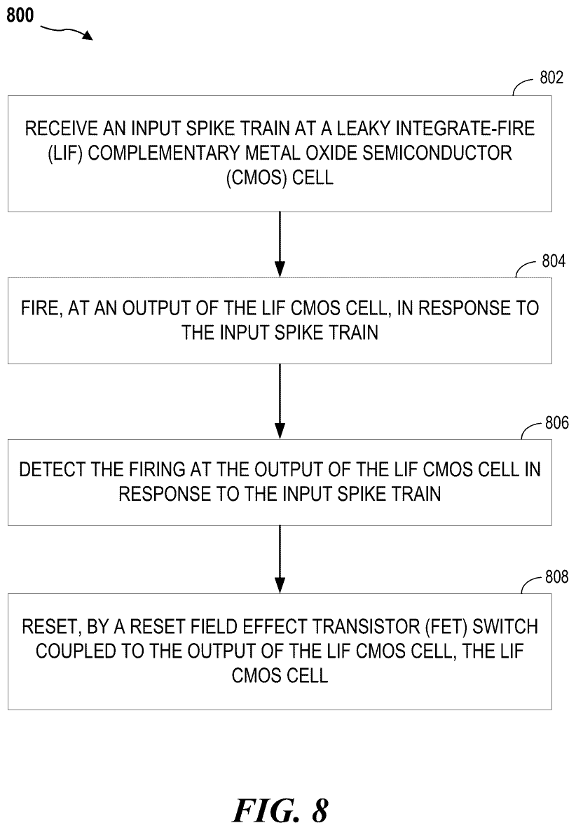

In this example, the LIF CMOS cell 710 includes a first diode 712 having a cathode configured to receive the input spike train (e.g., Iᵢₙₚᵤₜ). Additionally, the LIF CMOS cell 710 includes a second diode 714 having an anode coupled to an anode of the first diode 712 at the output of the LIF CMOS cell 710. In operation, an output of the LIF CMOS cell 710 is configured to fire in response to the input spike train from, for example, a spike generator. Additionally, the IC 700 includes the reset FET switch 520 coupled to the output of the LIF CMOS cell 710 to detect the fire in response to the input spike train and reset the LIF CMOS cell 710. A leaky integrate-fire and reset (LIFR) process is illustrated, for example, in FIG. 8.

FIG. 8 is a flow diagram illustrating a method for leaky integrate-fire and reset (LIFR) on a neuromorphic computing (NC) hardware activation (NCHWA) of a neural processing unit (NPU), according to various aspects of the present disclosure. A method 800 begins at block 802, in which an input spike train is received at a leaky integrate-fire (LIF) complementary metal oxide semiconductor (CMOS) cell. For example, as shown in FIG. 5A, the IC 500 includes the LIF CMOS cell 510. In this example, the LIF CMOS cell 510 is coupled to the input spike train (e.g., Iᵢₙₚᵤₜ).

At block 804, an output of the LIF CMOS cell fires in response to the input spike train. For example, as shown in FIG. 5A, the LIF CMOS cell 510 is coupled to an input spike train (e.g., Iᵢₙₚᵤₜ), and an output of the LIF CMOS cell 510 is configured to fire in response to the input spike train from, for example, a spike generator.

At block 806, the firing is detected at the output of the LIF CMOS cell in response to the input spike train. For example, as shown in FIG. 5A, the IC 500 includes a reset field effect transistor (FET) switch 520 coupled to the output (e.g., the body) of the LIF CMOS cell 510 to detect the fire in response to the input spike train and reset the LIF CMOS cell 510.

At block 808, a reset field effect transistor (FET) switch coupled to the output of the LIF CMOS cell resets the LIF CMOS cell. For example, 5A, the IC 500 includes the reset FET switch 520 coupled to the output (e.g., the body) of the LIF CMOS cell 510 to detect the fire in response to the input spike train and reset the LIF CMOS cell 510. Additionally, in this example, an edge detector, or other like object detector/classifier is coupled to the body of the LIF CMOS cell 510.

In some aspects, the method 800 may be performed by the SoC 100 (FIG. 1). That is, each of the elements of method 800 may, for example, but without limitation, be performed by the SoC 100 or one or more processors (e.g., CPU 102 and/or NPU 130) and/or other components included therein.

Implementation examples are described in the following numbered clauses:
1. An integrated circuit (IC), comprising:
a leaky integrate-fire (LIF) complementary metal oxide semiconductor (CMOS) cell configured to receive an input spike train and having an output to fire in response to the input spike train; and
a reset field effect transistor (FET) switch coupled to the output of the LIF CMOS cell to detect the fire at the output of the LIF CMOS cell in response to the input spike train and to reset the LIF CMOS cell.
2. The IC of clause 1, in which the LIF CMOS cell comprises an N-type FET having a drain configured to receive to the input spike train and a body coupled to a source of the reset FET switch.
3. The IC of clause 1, in which the LIF CMOS cell comprises a P-type FET having a source configured to receive the input spike train and a body coupled to a drain of the reset FET switch.
4. The IC of clause 1, in which the LIF CMOS cell comprises:
a first diode having a cathode coupled to the input spike train; and
a second diode having an anode coupled to an anode of the first diode at the output of the LIF CMOS cell.
5 The IC of any of claims 1-4, in which the reset FET switch comprises a P-type FET having a source coupled to the output of the LIF CMOS cell.
6. The IC of any of claims 1-4, in which the reset FET switch comprises an N-type FET having a drain coupled to the output of the LIF CMOS cell.
7. The IC of any of claims 1-6, in which the LIF CMOS cell comprises a partially depleted (PD) semiconductor-on-insulator (SOI) (PDSOI) FET.
8. The IC of any of claims 1-7, in which the LIF CMOS cell comprises a four-terminal body contacted N-type FET.
9. The IC of any of claims 1-7, in which the LIF CMOS cell comprises a four-terminal body contacted P-type FET.
10. The IC of any of claims 1-9, in which a layout of the LIF CMOS cell comprises a diode-based cell layout.
11. A processor-implemented method for a leaky integrate-fire and reset (LIFR) on a neuromorphic computing (NC) hardware activation (NCHWA) of a neural processing unit (NPU), the method comprising:
receiving an input spike train at a leaky integrate-fire (LIF) complementary metal oxide semiconductor (CMOS) cell;
firing, at an output of the LIF CMOS cell, in response to the input spike train;
detecting the firing at the output of the LIF CMOS cell in response to the input spike train; and
resetting, by a reset field effect transistor (FET) switch coupled to the output of the LIF CMOS cell, the LIF CMOS cell.
12. The method of clause 11, in which the LIF CMOS cell comprises an N-type FET having a drain configured to receive to the input spike train and a body coupled to a source of the reset FET switch.
13. The method of clause 11, in which the LIF CMOS cell comprises a P-type FET having a source configured to receive the input spike train and a body coupled to a drain of the reset FET switch.
14. The method of clause 11, in which the LIF CMOS cell comprises:
a first diode having a cathode coupled to the input spike train; and
a second diode having an anode coupled to an anode of the first diode at the output of the LIF CMOS cell.
15. The method of any of claims 11-14, in which the reset FET switch comprises a P-type FET having a source coupled to the output of the LIF CMOS cell.
16. The method of any of claims 11-14, in which the reset FET switch comprises an N-type FET having a drain coupled to the output of the LIF CMOS cell.
17. The method of claim 11, in which the LIF CMOS cell comprises a partially depleted (PD) semiconductor-on-insulator (SOI) (PDSOI) FET.
18. The method of any of claims 11-17, in which the LIF CMOS cell comprises a four-terminal body contacted N-type FET.
19. The method of any of claims 11-17, in which the LIF CMOS cell comprises a four-terminal body contacted P-type FET.
20. The method of any of claims 11-19, in which a layout of the LIF CMOS cell comprises a diode-based cell layout.

The various operations of methods described above may be performed by any suitable means capable of performing the corresponding functions. The means may include various hardware and/or software component(s) and/or module(s), including, but not limited to, a circuit, an application specific integrated circuit (ASIC), or processor. Where there are operations illustrated in the figures, those operations may have corresponding counterpart means-plus-function components with similar numbering.

As used, the term “determining” encompasses a wide variety of actions. For example, “determining” may include calculating, computing, processing, deriving, investigating, looking up (e.g., looking up in a table, a database, or another data structure), ascertaining and the like. Additionally, “determining” may include receiving (e.g., receiving information), accessing (e.g., accessing data in a memory) and the like. Furthermore, “determining” may include resolving, selecting, choosing, establishing, and the like.

As used, a phrase referring to “at least one of” a list of items refers to any combination of those items, including single members. As an example, “at least one of: a, b, or c” is intended to cover: a, b, c, a-b, a-c, b-c, and a-b-c.

The various illustrative logical blocks, modules and circuits described in connection with the present disclosure may be implemented or performed with a general-purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read-only memory (ROM), flash memory, erasable programmable read-only memory (EPROM), electrically erasable programmable read-only memory (EEPROM), registers, a hard disk, a removable disk, a CD-ROM, and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed, include one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a device. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement signal processing functions. For certain aspects, a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and general processing, including the execution of software stored on the machine-readable media. The processor may be implemented with one or more general purpose and/or special-purpose processors. Examples include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, random access memory (RAM), flash memory, read-only memory (ROM), programmable read-only memory (PROM), erasable programmable read-only memory (EPROM), electrically erasable programmable read-only memory (EEPROM), registers, magnetic disks, optical disks, hard drives, or any other suitable storage medium, or any combination thereof. The machine-readable media may be embodied in a computer-program product. The computer-program product may comprise packaging materials.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the device, all which may be accessed by the processor through the bus interface. Alternatively, or in addition, the machine-readable media, or any portion thereof, may be integrated into the processor, such with cache and/or general register files. Although the various components discussed may be described as having a specific location, such as a local component, they may also be configured in several ways, such as certain components being configured as part of a distributed computing system.

The processing system may be configured as a general-purpose processing system with one or more microprocessors providing the processor functionality and external memory providing at least a portion of the machine-readable media, all linked together with other supporting circuitry through an external bus architecture. Alternatively, the processing system may comprise one or more neuromorphic processors for implementing the neuron models and models of neural systems described. As another alternative, the processing system may be implemented with an application specific integrated circuit (ASIC) with the processor, the bus interface, the user interface, supporting circuitry, and at least a portion of the machine-readable media integrated into a single chip, or with one or more field programmable gate arrays (FPGAs), programmable logic devices (PLDs), controllers, state machines, gated logic, discrete hardware components, or any other suitable circuitry, or any combination of circuits that can perform the various functionality described throughout this disclosure. Those skilled in the art will recognize how best to implement the described functionality for the processing system depending on the application and the overall design constraints imposed on the overall system.

The machine-readable media may comprise several software modules. The software modules include instructions that, when executed by the processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module. Furthermore, it should be appreciated that aspects of the present disclosure result in improvements to the functioning of the processor, computer, machine, or other system implementing such aspects.

If implemented in software, the functions may be stored or transmitted over as one or more instructions or code on a computer-readable medium. Computer-readable media include both computer storage media and communication media including any medium that facilitates transfer of a computer program from one place to another. A storage medium may be any available medium that can be accessed by a computer. By way of example, and not limitation, such computer-readable media can comprise RAM, ROM, EEPROM, CD-ROM or other optical disk storage, magnetic disk storage, or other magnetic storage devices, or any other medium that can be used to carry or store desired program code in the form of instructions or data structures and that can be accessed by a computer. Additionally, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc, where disks usually reproduce data magnetically, while discs reproduce data optically with lasers. Thus, in some aspects, computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented. For example, such a computer program product may comprise a computer-readable medium having instructions stored (and/or encoded) thereon, the instructions being executable by one or more processors to perform the operations described herein. For certain aspects, the computer program product may include packaging material.

Further, it should be appreciated that modules and/or other appropriate means for performing the methods and techniques described herein, may be downloaded and/or otherwise obtained by a user terminal and/or base station as applicable. For example, such a device can be coupled to a server to facilitate the transfer of means for performing the methods described herein. Alternatively, various methods described herein, may be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes, and variations may be made in the arrangement, operation, and details of the methods and apparatus described above without departing from the scope of the claims.

What is claimed is:

1. An integrated circuit (IC), comprising:
a leaky integrate-fire (LIF) complementary metal oxide semiconductor (CMOS) cell configured to receive an input spike train and having an output to fire in response to the input spike train; and
a reset field effect transistor (FET) switch coupled to the output of the LIF CMOS cell to detect the fire at the output of the LIF CMOS cell in response to the input spike train and to reset the LIF CMOS cell.

2. The IC of claim 1, in which the LIF CMOS cell comprises an N-type FET having a drain configured to receive to the input spike train and a body coupled to a source of the reset FET switch.

3. The IC of claim 1, in which the LIF CMOS cell comprises a P-type FET having a source configured to receive the input spike train and a body coupled to a drain of the reset FET switch.

4. The IC of claim 1, in which the LIF CMOS cell comprises:
a first diode having a cathode coupled to the input spike train; and
a second diode having an anode coupled to an anode of the first diode at the output of the LIF CMOS cell.

5. The IC of claim 1, in which the reset FET switch comprises a P-type FET having a source coupled to the output of the LIF CMOS cell.

6. The IC of claim 1, in which the reset FET switch comprises an N-type FET having a drain coupled to the output of the LIF CMOS cell.

7. The IC of claim 1, in which the LIF CMOS cell comprises a partially depleted (PD) semiconductor-on-insulator (SOI) (PDSOI) FET.

8. The IC of claim 1, in which the LIF CMOS cell comprises a four-terminal body contacted N-type FET.

9. The IC of claim 1, in which the LIF CMOS cell comprises a four-terminal body contacted P-type FET.

10. The IC of claim 1, in which a layout of the LIF CMOS cell comprises a diode-based cell layout.

11. A processor-implemented method for a leaky integrate-fire and reset (LIFR) on a neuromorphic computing (NC) hardware activation (NCHWA) of a neural processing unit (NPU), the method comprising:
receiving an input spike train at a leaky integrate-fire (LIF) complementary metal oxide semiconductor (CMOS) cell;
firing, at an output of the LIF CMOS cell, in response to the input spike train;
detecting the firing at the output of the LIF CMOS cell in response to the input spike train; and
resetting, by a reset field effect transistor (FET) switch coupled to the output of the LIF CMOS cell, the LIF CMOS cell.

12. The method of claim 11, in which the LIF CMOS cell comprises an N-type FET having a drain configured to receive to the input spike train and a body coupled to a source of the reset FET switch.

13. The method of claim 11, in which the LIF CMOS cell comprises a P-type FET having a source configured to receive the input spike train and a body coupled to a drain of the reset FET switch.

14. The method of claim 11, in which the LIF CMOS cell comprises:
a first diode having a cathode coupled to the input spike train; and
a second diode having an anode coupled to an anode of the first diode at the output of the LIF CMOS cell.

15. The method of claim 11, in which the reset FET switch comprises a P-type FET having a source coupled to the output of the LIF CMOS cell.

16. The method of claim 11, in which the reset FET switch comprises an N-type FET having a drain coupled to the output of the LIF CMOS cell.

17. The method of claim 11, in which the LIF CMOS cell comprises a partially depleted (PD) semiconductor-on-insulator (SOI) (PDSOI) FET.

18. The method of claim 11, in which the LIF CMOS cell comprises a four-terminal body contacted N-type FET.

19. The method of claim 11, in which the LIF CMOS cell comprises a four-terminal body contacted P-type FET.

20. The method of claim 11, in which a layout of the LIF CMOS cell comprises a diode-based cell layout.
